(19) United States
(12) Patent Application Publication
(10) Pub. No.: US 2021/0383961 A1
(43) Pub. Date: Dec. 9, 2021

(54) TRANSFORMER

(71) Applicant: Sanil Electric Co., Ltd., Gyeonggi-do (KR)

(72) Inventors: Dong Suk PARK, Seoul (KR); Bum In SHIN, Seoul (KR)

(73) Assignee: Sanil Electric Co., Ltd., Gyeonggi-do (KR)

(21) Appl. No.: 17/177,967

(22) Filed: Feb. 17, 2021

(30) Foreign Application Priority Data
Jun. 9, 2020 (KR) 10-2020-0069472

(51) Int. Cl. H01F 27/34; H01F 27/02; H01F 27/36; H01F 27/24; H01F 27/30; H01F 41/04

(52) U.S. Cl. CPC H01F 27/346; H01F 27/02; H01F 41/04; H01F 27/24; H01F 27/306; H01F 27/363

(57) ABSTRACT

Disclosed is a transformer capable of minimizing power loss during a transformation process by reducing stray load loss that occurs at a portion connecting low-voltage bushings. The transformer includes an enclosure disposed so as to surround power conversion equipment mounted therein, a pair of low-voltage bushings configured to transform the voltage of power received from a high-voltage bushing disposed on one side of the enclosure and to output the power, and a shielding member disposed near the pair of low-voltage bushings on the enclosure.

This application claims the benefit of Korean Patent Application No. 10-2020-0069472, filed on Jun. 9, 2020 which is hereby incorporated by reference as if fully set forth herein.

### BACKGROUND OF THE INVENTION

### Field of the Invention

The present invention relates to a transformer, and more particularly to a transformer capable of minimizing power loss during a transformation process by reducing stray load loss that occurs at a portion connecting low-voltage bushings.

### Discussion of the Related Art

In general, a transformer is a device that changes the voltage value or the current value of alternating current (AC) using an electromagnetic induction phenomenon, and is abbreviated as “transformer”. A transformer is usually used to convert a certain voltage value into a required value.

A transformer is basically structured such that coils are wound around opposite sides of a core to form a primary winding and a secondary winding. The core is used as a path for magnetic flux. When an AC power source is connected to the primary winding, current flows therethrough, and alternating magnetic flux is generated in the core.

Because this magnetic flux links with the secondary winding and changes alternately depending on the frequency of alternating current, voltage is generated in the secondary winding. In this way, voltage is capable of being adjusted using the primary winding and the secondary winding.

In a transformer, in the process of converting power, various types of loss occur depending on the material, type, and cross-sectional area of a winding. Loss may be broadly classified into no-load loss and load loss.

No-load loss is classified into hysteresis loss and eddy current loss. Hysteresis loss is power that is lost by inertia in which alternation of a magnetic field occurs when alternating current of a transformer induces an alternating magnetic field in a core.

The magnitude of hysteresis loss is related to the material of the core, the frequency of current, the magnetic flux density of the core, etc. Eddy current loss is energy that is consumed in the form of Joule heat by eddy current induced in the core by an alternating magnetic field. The magnitude of eddy current loss is related to the material of the core, a frequency, a magnetic flux density, the thickness of the core, etc.

Load loss is classified into copper loss and stray load loss. Copper loss is Joule loss that occurs due to the resistance of a winding, and stray load loss is eddy current loss that occurs due to linkage of leakage flux of a core and a winding with an enclosure or an external conductor.

However, among the aforementioned types of transformer loss, the exact cause of stray load loss is not known, and technology for effectively reducing stray load loss has not been developed. Therefore, research on the cause of stray load loss and a method of reducing the same is underway.

### SUMMARY OF THE INVENTION

Therefore, the present invention has been made in view of the above problems, and it is an object of the present invention to provide a transformer capable of reducing stray load loss that occurs at a portion connecting a pair of low-voltage bushings in an enclosure of the transformer.

In accordance with the present invention, the above and other objects can be accomplished by the provision of a transformer including an enclosure disposed so as to surround power conversion equipment mounted therein, a pair of low-voltage bushings configured to transform the voltage of power received from a high-voltage bushing disposed on one side of the enclosure and to output the power, and a shielding member disposed near the pair of low-voltage bushings on the enclosure.

The shielding member may shield an opening in the enclosure that is formed by cutting a portion of the enclosure around the pair of low-voltage bushings. The shielding member may have a shape corresponding to the shape of the opening, and may be made of a nonmagnetic material.

The shielding member may include at least one nonmagnetic material selected from the group consisting of stainless steel, aluminum, copper, and high manganese steel.

The shielding member may cover all of the pair of low-voltage bushings, and may be formed in a polygonal shape having three or more vertices, a circular shape, or an elliptical shape.

The shielding member may include a first region formed around one of the pair of low-voltage bushings and a second region formed around the remaining one of the pair of low-voltage bushings so as to be spaced apart from the first region.

The shielding member may further include a third region integrally connecting the first region and the second region to each other.

The third region may be formed to have a width smaller than the width of the first region or the second region.

The transformer may further include a transformation device, and the transformation device may include a core mounted in the enclosure, at least two coils disposed around the core, and a clamp surrounding the at least two coils or the core.

The clamp may include first cover members covering the side surfaces of the core that are exposed above or below the at least two coils and a second cover member connecting the first cover members to each other and disposed so as to cover at least one side surface of each of the at least two coils.

The clamp may be made of a material including at least one nonmagnetic material selected from the group consisting of stainless steel, aluminum, copper, and high manganese steel.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view showing a transformer according to an embodiment of the present invention;

FIG. 2 is a side view showing the side surface of the transformer shown in FIG. 1;

FIG. 3 is a plan view showing the upper surface of the transformer shown in FIG. 1;

FIG. 4 is a reference view showing a low-voltage bushing of the transformer shown in FIG. 1 and shielding members according to various embodiments;

FIGS. 5A and 5B are reference diagrams showing numerical analysis of stray load loss in a transformer to which a shielding member according to a first embodiment of the present invention is applied;

FIGS. 6A and 6B are reference diagrams showing numerical analysis of stray load loss in a transformer to which a shielding member according to a second embodiment of the present invention is applied;

FIGS. 7A and 7B are reference diagrams showing numerical analysis of stray load loss occurring around a low-voltage bushing in a conventional transformer;

FIG. 8 is a perspective view showing a transformation device mounted in the transformer shown in FIG. 1;

FIG. 9 is a front view showing the front surface of the transformer shown in FIG. 8;

FIG. 10 is a reference diagram showing numerical analysis of stray load loss in the transformer of the present invention and the conventional transformer; and

FIG. 11 is a reference diagram showing numerical analysis of stray load loss depending on the material of an enclosure and the material of a clamp in the transformer of the present invention and the conventional transformer.

### DETAILED DESCRIPTION OF THE INVENTION

Hereinafter, exemplary embodiments of the present invention will be described in detail with reference to the accompanying drawings so as for those skilled in the art to easily carry out the embodiments. In the drawings, the same Or similar elements are denoted by the same reference numerals even though they are depicted in different drawings. In the following description of the present invention, a detailed description of known functions and configurations incorporated herein will be omitted when it may make the subject matter of the present invention rather unclear. Some features illustrated in the drawings are exaggerated, reduced or simplified for convenience in description and clarity, and the drawings and elements in the drawings are not always illustrated at the actual scale. However, these details will be easily understood by those skilled in the art.

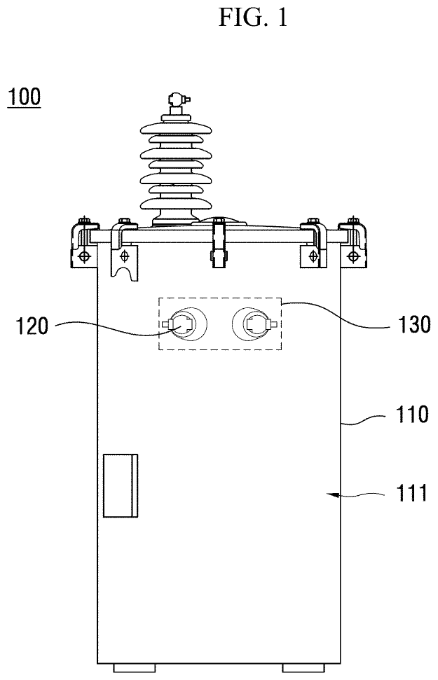

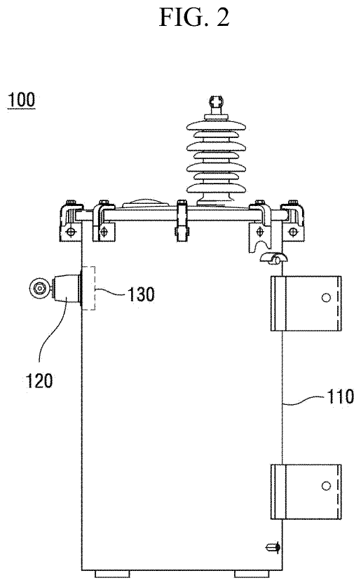

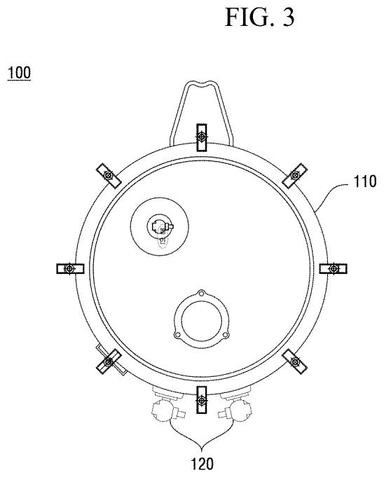

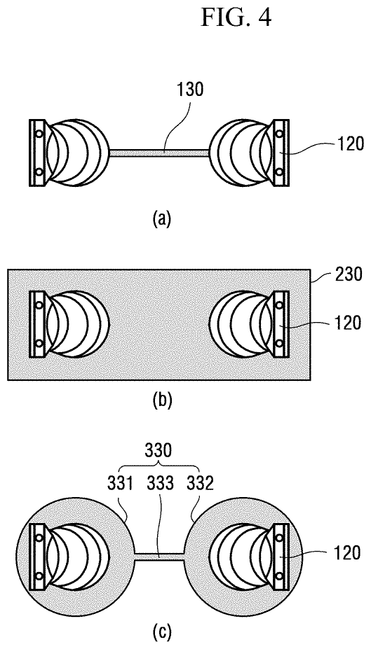

FIG. 1 is a front view showing a transformer according to an embodiment of the present invention, FIG. 2 is a side view showing the side surface of the transformer shown in FIG. 1, FIG. 3 is a plan view showing the upper surface of the transformer shown in FIG. 1, and FIG. 4 is a reference view showing a low-voltage bushing 120 of the transformer shown in FIG. 1 and shielding members 130, 230 and 330 according to various embodiments.

A transformer 100 is provided in a power system, and serves to receive voltage from a power plant and to transmit power to a consumer after raising or lowering the voltage. In order to realize stable operation, the transformer needs to be securely installed and fixed so as not to be shaken by external force, and this fixed state needs to be constantly maintained.

Referring to FIGS. 1 to 4, the transformer 100 includes power conversion equipment (not shown), such as a transformer coil (not shown) composed of a primary coil and a secondary coil (not shown) and a field core for smoothly realizing mutual induction action of the transformer coil, an enclosure 110 for accommodating the power conversion equipment, a high-voltage bushing disposed on one side of the enclosure 110, a low-voltage bushing 120, and a shielding member 130 (230 or 330) provided near the low-voltage bushing 120. In addition, although not shown in the drawings, in the case in which the transformer 100 is an oil-immersed transformer, the transformer 100 may include a heat dissipation unit, which protrudes outwards from the enclosure 110 in order to dissipate heat from insulation oil stored in the enclosure 110.

The enclosure 110 has an accommodation space 111 formed therein, and the power conversion equipment is mounted in the accommodation space 111. The high-voltage or low-voltage bushing 120, which is connected to the power conversion equipment, may be disposed on the outer side of the enclosure 110.

Although not shown in the drawings, a reinforcing frame or panel (not shown), which has a shape corresponding to the shape of the accommodation space 111, may be provided between the enclosure 110 and the power conversion equipment in order to increase the rigidity of the enclosure 110.

In general, the high-voltage bushing is disposed on the upper portion of the enclosure 110, and the low-voltage bushing 120 is disposed on the side portion of the enclosure 110. However, the positions of the high-voltage bushing and the low-voltage bushing 120 are not limited thereto. In the case of a pole transformer installed on a roadside, it is installed on a pole such that a high-voltage trunk line is connected to the high-voltage bushing via a branch line. In this case, the power conversion equipment performs voltage transformation, and voltage is applied to a consumer via the low-voltage bushing 120.

The transformer is mainly used to convert voltage applied to a high-voltage distribution line into voltage suitable for homes or offices. In general, the value of voltage that is applied to a high-voltage distribution line is 6,600V, and the value of low-voltage distribution voltage is 220V (three-phase three-wire).

In the case of a transformer having a large capacity, a heat dissipation structure may be further provided in order to dissipate heat generated during the power conversion process. Hereinafter, the transformer according to the present invention will be described as being a single-phase transformer having a rated capacity of 100 kVA (rated current of 7.58/434.8 A and rated voltage of 13,200/230 V). The following description may also apply to three-phase transformers having other capacities.

The shielding member 130 (230 or 330) may be provided near the low-voltage bushing 120 on the enclosure 110. As shown in FIG. 4, the shielding member may be implemented in various forms.

FIG. 4(a) shows a shielding member according to a first embodiment. As shown, the shielding member may be disposed so as to connect a pair of low-voltage bushings 120 to each other.

In this case, a slit-shaped opening is formed in the enclosure 110 by cutting a portion of the enclosure 110, and the shielding member 130 is coupled to the enclosure 110 so as to shield the opening. The shielding member 130 may be disposed on the inner side or outer side of the enclosure 110 due to the slit-shaped opening, or may be welded onto the slit-shaped opening in the enclosure 110.

FIG. 4(b) shows a shielding member 230 according to a second embodiment. As shown, an opening may be formed in the enclosure 110 by cutting a portion of the enclosure 110 around a pair of low-voltage bushings 120, and a rectangular-shaped shielding member 230 may shield the opening so as to surround the low-voltage bushings 120.

Therefore, since the portion of the enclosure 110 around the low-voltage bushings 120 is formed by the shielding member 230, the enclosure 110 and the shielding member 230 may be formed in an integrated shape. Of course, the shape of the shielding member 230 is not limited to a rectangular shape. The shielding member 230 may be formed in a circular, elliptical, or polygonal shape, so long as it is capable of surrounding the low-voltage bushings 120.

FIG. 4(c) shows a shielding member 330 according to a third embodiment. As shown, the shielding member 330 includes a first region 331, which is formed around one of the pair of low-voltage bushings 120, a second region 332, which is formed around the other one of the pair of low-voltage bushings 120, and a third region 333, which connects the first region 331 and the second region 332 to each other.

Although the first region 331 and the second region 332 are illustrated in the drawing as having a circular shape, each of the first region 331 and the second region 332 may have a polygonal shape having three or more vertices or an elliptical shape.

The third region 333 has a shape similar to that of the shielding member 130 that shields the slit-shaped opening in the first embodiment. That is, the difference from the shielding member of the first embodiment is that the first region 331 and the second region 332 are further provided around the low-voltage bushings 120. In this case, the width of the third region 333 may be formed smaller than that of the first region 331 or the second region 332.

The shielding member 130, 230 or 330 of each embodiment may be formed in a shape corresponding to the shape of the opening. The shielding member may include at least one nonmagnetic material selected from the group consisting of stainless steel, aluminum, copper, and high manganese steel. Of course, the shielding member 130, 230 or 330 may have a shape larger than that of the opening.

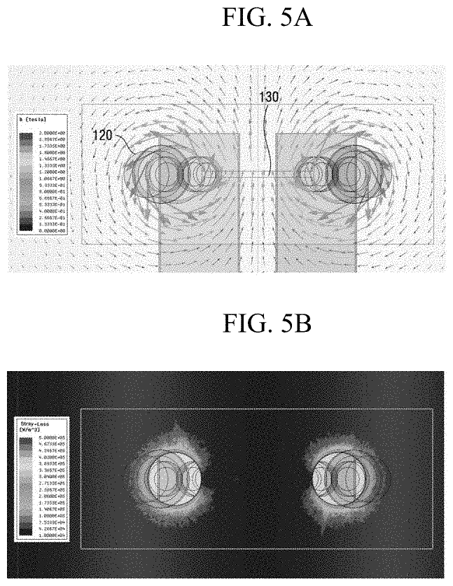

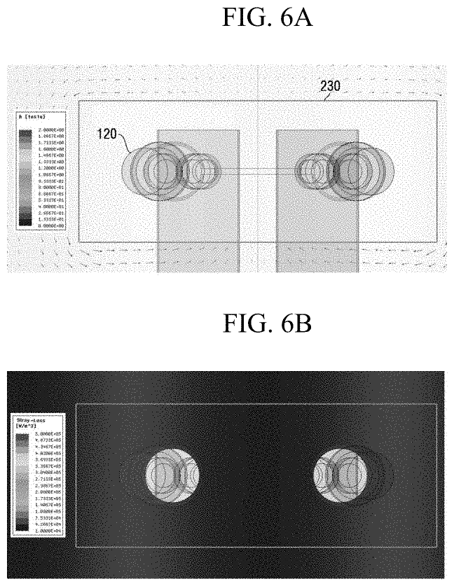

The effects of the shielding members 130 and 230 according to the first and second embodiments described above will be described in detail with reference to FIGS. 5 and 6. Hereinafter, the shielding members 130 and 230 according to the first and second embodiments will be described as being made of stainless steel (STS304), but the embodiments are not limited thereto.

FIGS. 5A and 5B are reference diagrams showing numerical analysis of stray load loss in the transformer according to the first embodiment of the present invention, to which the shielding member 130 is applied.

Referring to FIGS. 4(a) and 5, the transformer according to the first embodiment is structured such that a slit-shaped opening is formed in the enclosure 110 and the shielding member 130 is coupled to the enclosure 110 so as to shield the slit-shaped opening.

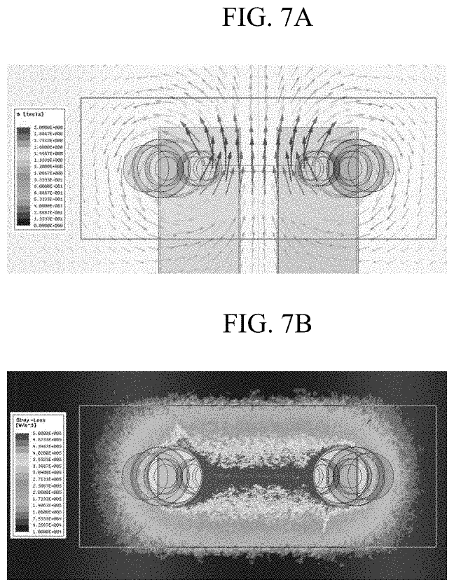

Referring to FIGS. 5A and 5B, it can be seen that greater stray load loss occurs around the pair of low-voltage bushings 120, which are spaced apart from each other, than in the low-voltage bushings 120 and a distant region. For reference, FIGS. 7A and 7B show numerical analysis of stray load loss in a general transformer having no shielding member. It can be seen from FIG. 5A that the transformer according to the first embodiment of the present invention may reduce stray load loss by about 85.9% using the shielding member 130 compared to the general transformer.

The stray load loss in the transformer according to the first embodiment of the present invention was measured to be 1.49 W, and the stray load loss in the general transformer was measured to be about 10.56 W. That is, it can be seen that a significant amount of stray load loss occurs in the region between the pair of low-voltage bushings 120.

FIGS. 6A and 6B are reference diagrams showing numerical analysis of stray load loss in the transformer according to the second embodiment of the present invention, to which the shielding member 230 is applied.

Referring to FIGS. 4(b) and 6, the transformer according to the second embodiment is structured such that a rectangular-shaped opening is formed in the enclosure 110 by cutting a portion of the enclosure 110 around the pair of low-voltage bushings 120 and the shielding member 230 is coupled to the enclosure 110 so as to shield the rectangular-shaped opening.

Referring to FIGS. 6A and 6B, it can be seen that stray load loss is greatly reduced around the pair of low-voltage bushings 120 by the shielding member 230. As shown in FIG. 7, the stray load loss around the low-voltage bushings 120 in the transformer according to the second embodiment was measured to be 0.17 W, and the stray load loss around the low-voltage bushings 120 in the general transformer was measured to be about 10.56 W.

That is, the transformer according to the second embodiment may reduce stray load loss by about 98.4% using the shielding member 230 compared to the general transformer. As such, it is possible to minimize the stray load loss.

Although the numerical analysis of the third embodiment shown in FIG. 4(c) is not shown in the drawings, it is determined that the third embodiment, which includes the shielding member 330 provided in a minimum area around the low-voltage bushings, is expected to exhibit stray load loss reduction effect similar to that of the second embodiment including the shielding member 230.

As described above, according to the transformer of the present invention, since it can be confirmed that most stray load loss occurs around the low-voltage bushings 120, it is possible to easily determine a method of effectively reducing stray load loss and to minimize stray load loss through simple improvement of the structure thereof.

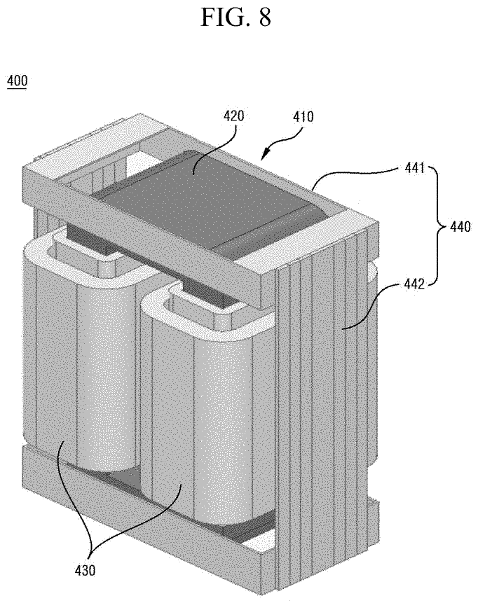

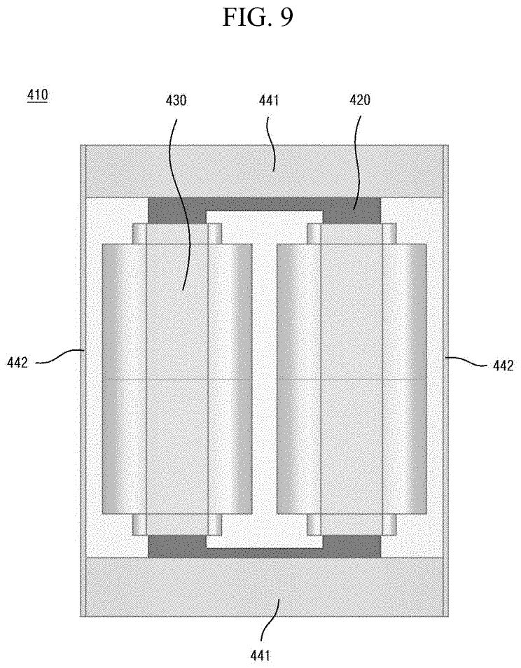

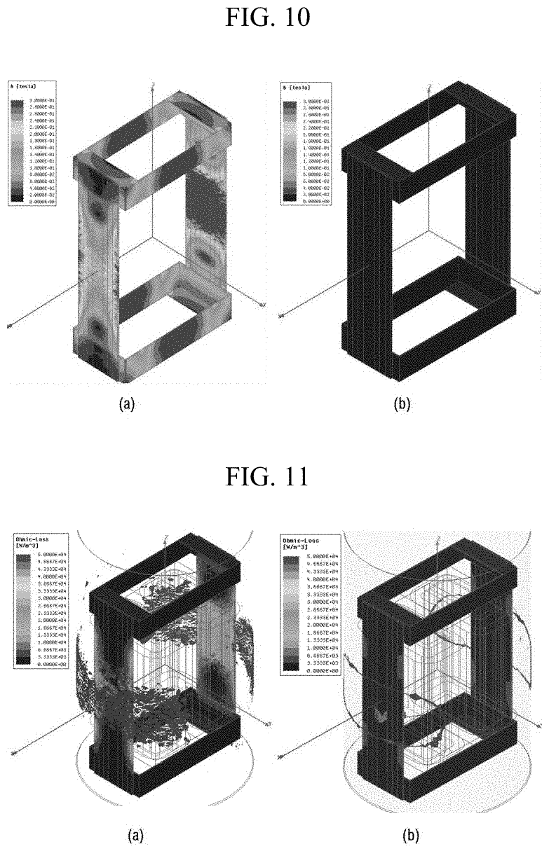

FIG. 8 is a perspective view showing a transformation device mounted in the transformer shown in FIG. 1, FIG. 9 is a front view showing the front surface of the transformer shown in FIG. 8, FIG. 10 is a reference diagram showing numerical analysis of stray load loss in the transformer of the present invention and the conventional transformer, and FIG. 11 is a reference diagram showing numerical analysis of stray load loss depending on the material of the enclosure and the material of the clamp in the transformer of the present invention and the conventional transformer.

Referring to the drawings, in the transformer of the present invention, the enclosure 110 has an accommodation space 111 (refer to FIG. 1) formed therein, and the power conversion equipment is mounted in the accommodation space 111. As shown in FIG. 8, the power conversion equipment includes a transformation device 410.

The transformation device 410 may include a core 420, coils 430, and a clamp 440. Hereinafter, this embodiment will be described as including a core-type transformation device. However, a shell-type transformation device may also be applied to this embodiment.

The insulated coils 430 are disposed on opposite sides of the core 420. The coils 430 disposed on opposite sides may have different winding ratios from each other. Although not shown in the drawings, the power conversion equipment may include a tap changer. The tap changer may change the turn ratio between windings, and may perform a change in a load or no-load state.

The clamp 440 may be coupled to the outer side of the transformation device 410. The clamp 440 may serve to fix the transformation device 410 to the inner side of the enclosure 110 and to securely support the engagement position of the transformation device 410. In addition, the clamp 440 may be disposed so as to surround the coils 430 or the core 410, thereby blocking at least a portion of leakage flux, thus reducing stray load loss.

The clamp 440 includes at least one or a plurality of first support members 441, which cover and support the side portions of the core 420 that are exposed above and/or below the coils 430, and a second support member 442, which covers one side surface of each of the coils 430. That is, the first support members 441 may be disposed in a horizontal direction around the upper and lower portions of the core 420 above and below the coils 430, and the second support member 442 may be disposed in a vertical direction so as to connect the first support members 441, disposed around the upper and lower portions of the core 420, to each other.

The horizontal direction and the vertical direction are relative concepts and can be changed to each other depending on the installation direction or location. In addition, the first support members 441 may be disposed so as to further cover the upper surface or the lower surface of the core 420, and the second support member 442 may be disposed so as to cover all of the side surfaces of the coils 430.

In this case, the clamp 440 may be made of a material including at least one nonmagnetic material selected from the group consisting of stainless steel, aluminum, copper, and high manganese steel, like the shielding member described above. The clamp 440 may be provided in a manner of attaching or coating one layer made of this nonmagnetic material.

FIG. 10(a) shows a conventional transformation device, and FIG. 10(b) shows the transformation device of the present invention. As shown in the drawings, in the case of the conventional transformation device, which is made of general iron (SS400), the change in color is large and clear. However, in the case of the transformation device of the present invention, which is made of high manganese steel, there is little change in color.

The change in color indicates stray load loss that occurs in each of the transformation devices. It can be seen from the change in color that the transformation device of the present invention is capable of greatly reducing stray load loss. Numerically, the stray load loss in the conventional transformation device is 6.446 W, and the stray load loss in the transformation device according to the present invention is 1.2156 W. That is, the transformation device of the present invention is capable of reducing stray load loss by about 80% or more.

FIG. 11 shows stray load loss depending on the material of the enclosure and the transformation device. FIG. 11(a) shows the stray load loss in the enclosure and the transformation device of the conventional art, and FIG. 11(b) shows the stray load loss in the enclosure and the transformation device of the present invention.

The enclosure and the transformation device of the conventional art are made of general iron, and the enclosure and the transformation device of the present invention are made of high manganese steel. As a result, the total stray load loss in the conventional art is 9.697 W, and the total stray load loss in the enclosure and the transformation device of the present invention is 6.6373 W. Therefore, it can be seen that the stray load loss is reduced by about 31.55% compared to the conventional art.

As a result, when high manganese steel is applied to a transformer, among nonmagnetic materials, it is possible to reduce stray load loss and thus to increase operational efficiency.

As is apparent from the above description, according to a transformer of the present invention, since it can be confirmed that most stray load loss occurs around a low-voltage bushing and a transformation device, it is possible to determine a method of effectively reducing stray load loss and to reduce stray load loss through simple improvement of the structure thereof.

Although the present invention has been described with reference to the preferred embodiments, it is to be understood that various modifications or changes can be made without departing from the technical spirit and the scope of the invention as disclosed in the accompanying claims by those skilled in the art. Therefore, the scope of the present invention should be interpreted by the following claims, which have been set forth so as to include such various changes.

What is claimed is:

1. A transformer, comprising:
an enclosure disposed so as to surround power conversion equipment mounted therein;
a pair of low-voltage bushings configured to transform a voltage of power received from a high-voltage bushing disposed on one side of the enclosure and to output the power; and
a shielding member disposed near the pair of low-voltage bushings on the enclosure.

2. The transformer according to claim 1, wherein the shielding member shields an opening in the enclosure that is formed by cutting a portion of the enclosure around the pair of low-voltage bushings, and
wherein the shielding member has a shape corresponding to a shape of the opening, and is made of a nonmagnetic material.

3. The transformer according to claim 2, wherein the shielding member comprises at least one nonmagnetic material selected from the group consisting of stainless steel, aluminum, copper, and high manganese steel.

4. The transformer according to claim 2, wherein the shielding member covers all of the pair of low-voltage bushings, and is formed in a polygonal shape having three or more vertices, a circular shape, or an elliptical shape.

5. The transformer according to claim 2, wherein the shielding member comprises:
a first region formed around one of the pair of low-voltage bushings; and
a second region formed around a remaining one of the pair of low-voltage bushings so as to be spaced apart from the first region.

6. The transformer according to claim 5, wherein the shielding member further comprises:
a third region integrally connecting the first region and the second region to each other.

7. The transformer according to claim 6, wherein the third region is formed to have a width smaller than a width of the first region or the second region.

8. The transformer according to claim 1, further comprising:
a transformation device, the transformation device comprising:
a core mounted in the enclosure;
at least two coils disposed around the core; and
a clamp surrounding the at least two coils or the core.

9. The transformer according to claim 8, wherein the clamp comprises:
first cover members covering side surfaces of the core that are exposed above or below the at least two coils; and
a second cover member connecting the first cover members to each other and disposed so as to cover at least one side surface of each of the at least two coils.

10. The transformer according to claim 9, wherein the clamp is made of a material comprising at least one nonmagnetic material selected from the group consisting of stainless steel, aluminum, copper, and high manganese steel.
